(19) United States
(12) Patent Application Publication
(10) Pub. No.: US 2016/0000020 A1
(43) Pub. Date: Jan. 7, 2016

(54) CULTIVATION SYSTEM, CULTIVATION PROGRAM, AND CULTIVATION METHOD

(71) Applicant: BRILLIANTSERVICE CO., LTD., Osaka-shi, Osaka (JP)

(72) Inventor: Yoshihiko Sugimoto, Osaka-shi, Osaka (JP)

(21) Appl. No.: 14/765,083

(22) PCT Filed: Jan. 31, 2014
(86) PCT No.: PCT/JP2014/000517

§ 371 Date: Jul. 31, 2015

(30) Foreign Application Priority Data
Feb. 1, 2013 (JP) PCT/JP2013/000582
Feb. 1, 2013 (JP) PCT/JP2013/000583

(51) Int. Cl. A01G 9/02

(52) U.S. Cl. CPC A01G 9/02

(57) ABSTRACT

There are provided a cultivation system, a cultivation program, and a cultivation method that utilize, as big data, information about control performed on cultivation apparatuses by users and give back, by automatic analysis, the information to the users in a mode where the users can use the information in the cultivation system, by which use of the cultivation system is promoted, creating a virtuous cycle of creation of more useful plants. A cultivation system 100 includes a cultivation apparatus 300 and a communication terminal 200 that can communicate with a cloud 500. The cultivation apparatus 300 grows a plant, transmits growth information to the cloud 500, and receives raising control information from the cloud. The communication terminal 200 receives results of analysis performed by the cloud 500 on at least one of the growth information and the raising control information, and transmits raising control information generated based on the results of analysis to the cultivation apparatus 300 through the cloud 500.

### TECHNICAL FIELD

The present invention relates to a cultivation system, a cultivation program, and a cultivation method for a cultivation apparatus for growing plants such as vegetables, fruits, and flowers.

### BACKGROUND ART

Conventionally, a wide variety of experiments and studies have been performed for cultivation apparatuses. Patent Literature 1 discloses a plant cultivation system that artificially controls a cultivation environment and includes light sources that perform both raising and observation.

The plant cultivation system described in Patent Literature 1 is a plant cultivation system that cultivates a plant indoors and includes a cultivation cell which is a divided space for cultivating the plant, and managing means for managing the cultivation of the plant. The cultivation cell includes a cultivation rack which is a movable rack for cultivating the plant, and light-blocking means for blocking entry of sunlight into the divided space. The cultivation rack includes a cultivation shelf for cultivating the plant, and light control means for controlling a light with which the plant is irradiated. The cultivation shelf includes a light source that irradiates the plant with a light under control of the light control means by adjusting an amount of irradiation from a light emitter module having a plurality of light-emitting diodes, and observing means for observing the plant under the irradiation from the light emitter module to obtain observation data, and transmitting the obtained observation data to the managing unit. The light emitter module includes a first light-emitting diode that emits a light with a first spectrum, m (m is an integer greater than or equal to 2) second light-emitting diodes that are disposed on a circumference of a first circle having the first light-emitting diode at a center and that emit a light with a second spectrum, and n (n is an integer greater than or equal to 2) third light-emitting diodes that are disposed on a circumference of a second circle having the first light-emitting diode at a center and that emit a light with a third spectrum. The first spectrum, the second spectrum, and the third spectrum differ from one another. The second light-emitting diodes are disposed so as to be equal in number to n arcs of the first circle divided by rays passing through the third light-emitting diodes, respectively, with the first light-emitting diode being a starting point. The managing means includes receiving means for obtaining the observation data from the observing means, a library that records the observation data obtained by the receiving means, and computing means for estimating a harvest date of the plant by comparing the observation data obtained by the receiving means with past observation data of a plant of a same species as the plant recorded in the library.

In addition, Patent Literature 2 discloses a cultivation unit which can be easily set on a veranda, balcony, or the like in a house and in which cultivation can be managed by computer control.

The cultivation unit described in Patent Literature 2 includes a cultivation bed where compost is filled, a cover material that covers at least a top portion of the cultivation bed, watering and fertilizing means including a water tank, a liquid fertilizer tank, and piping connected to the water tank and the liquid fertilizer tank to supply water and a liquid fertilizer to the compost, a moisture meter that measures an amount of water retained in the compost, and a computer that records a cultivation management program for performing control not to cause water draining from the cultivation bed by adjusting, for each plant to be cultivated, amounts and times of supply of the water and the liquid fertilizer supplied from the watering and fertilizing means, based on a measurement value inputted from the moisture meter, to maintain the amount of water retained in the compost at a set amount. The cover material includes a transparent portion, a mesh tensioning portion made of mesh that can block entry of a harmful insect, and an opening/closing portion. The watering and fertilizing means is provided on an outer side of the cover material or the cultivation bed or a lower portion of the cultivation bed and is thereby integrally assembled therewith in advance. The computer is provided at a location where a cultivator can operate the computer, or is connectable to a computer of the cultivator, so that the cultivator can change a setting of a cultivation condition.

Furthermore, Patent Literature 3 discloses a plant cultivation system that can be widely applied to various species of plants and that can efficiently perform cultivation by promoting the growth of plants by suppressing the spread of bacteria and the like.

The plant cultivation system described in Patent Literature 3 includes cultivation beds in which cultivation plants are planted and which are arranged and held at a plurality of upper and lower levels and substantially horizontally to each other, an artificial light source that is provided above each of the cultivation beds and that is moved up and down depending on growth of the cultivation plant, and an air-conditioning apparatus that has a blower opening or a blower fan and that sequentially sends air whose temperature, humidity, CO2 concentration, and the like, are adjusted, into an air passage formed from one side to another side of each of the cultivation beds. The cultivation beds each include an open-topped box-shaped cultivation tank, and a planting panel that is fitted to a top portion of the cultivation tank and forms a flow path of a nutrient solution between the planting panel and a bottom of the cultivation tank, and places the cultivation plant in a planting state such that a plant root is exposed toward the flow path. The plant cultivation system is controlled such that the nutrient solution supplied to the cultivation bed continuously passes through the flow path and is drained and then is circulated and reused, and the nutrient solution intermittently flows into the flow path.

### CITATION LIST

### Patent Literatures

Patent Literature 1: JP 2012-39996 A

Patent Literature 2: JP 2011-36145 A

Patent Literature 3: JP 2010-88425 A

### SUMMARY OF THE INVENTION

### Technical Problem

However, all of the cultivation systems of Patent Literatures 1 to 3 are to set a cultivation apparatus nearby and perform cultivation of plants. In addition, all of the cultivation systems of Patent Literatures 1 to 3 are cultivation systems that can simply allow each individual to perform cultivation on their own.

An object of the present invention is to provide a cultivation system, a cultivation program, and a cultivation method that allow a user to check recorded history information even if he/she is far away from a cultivation unit, and achieve the growth of plants.

Furthermore, another object of the present invention is to create a virtuous cycle of creation of more useful plants by promoting use of the cultivation system, the cultivation program, and the cultivation method by the cultivation system, the cultivation program, and the cultivation method utilizing, as big data, information about control performed on cultivation apparatuses by users, and giving back, by automatic analysis, the information to the users in a mode where the users can use the information in the cultivation system.

### Solution to Problem

(1)

A cultivation system according to one aspect includes a cultivation apparatus and a communication terminal that can communicate with a cloud.

The cultivation apparatus grows a plant, transmits growth information to the cloud, and receives raising control information from the cloud.

The communication terminal receives a result of analysis performed by the cloud on at least one of the growth information and the raising control information, and transmits raising control information generated based on the result of analysis to the cultivation apparatus through the cloud.

By this, growth information transmitted from a cultivation apparatus which is controlled by a user and raising control information transmitted to the cultivation apparatus are analyzed by the cloud. In addition, the results of the analysis of the growth information and the raising control information are given back in a mode where the user him/herself can use the results of the analysis, to control the cultivation apparatus in the system. By this, use of the cultivation system by the user is promoted, creating a virtuous cycle of creation of more useful plants.

Note that the communication terminal includes a digital communication device that can communicate with a cloud, such as a smartphone, a tablet terminal, or a personal computer.

It is preferred that a recording apparatus that records the growth information transmitted from the cultivation apparatus, information on the analysis performed by the cloud, and the raising control information transmitted to the cloud from the communication terminal be included in the cloud.

(2)

The result of analysis performed by the cloud may be a raising control plan proposed by automatic feedback performed by the cloud.

In this case, the cloud automatically proposes a raising control condition suited to the growth state. Thus, by the user selecting the proposed raising control information, the user can use the results of analysis performed by the cloud, to control the cultivation apparatus controlled by the user. Therefore, the user can leave at least one of all or some of the steps in a raising step and all or some of a plurality of raising conditions to be provided simultaneously, to a cloud's judgment.

(3)

The result of analysis performed by the cloud may be information obtained by converting the result of analysis of the growth information into a simple display format.

In this case, since the result of analysis of a growth state is displayed in a format where the user can easily grasp the result at a glance, the user can easily grasp the growth state. In particular, general users with no expert knowledge can easily handle, for example, useful information about a growth state which is handled by experts such as researchers and producers (as expert information or as intuition).

Therefore, the user can set raising control conditions on his/her own, based on the information converted into a simple display format.

(4)

A part of the raising control information transmitted to the cultivation apparatus from the communication terminal may be based on the raising control information plan proposed by automatic feedback performed by the cloud.

In this case, the user can leave raising control information to a cloud's judgment, for at least one of only some of the steps in a raising step and some of a plurality of raising conditions to be provided simultaneously. Note that, for other steps and/or other conditions, the user can set raising control conditions based on, for example, at least one of his/her own judgment, his/her own rules of thumb, other users' judgments, and other users' rules of thumb (including raising control information acquired from other users). In this manner, user's original raising control information can be easily constructed.

(5)

One communication terminal that controls one cultivation apparatus through the cloud may be able to acquire raising control information for another cultivation apparatus controlled by another communication terminal through the cloud. In this case, a part of raising control information transmitted to the one cultivation apparatus from the one communication terminal is acquired raising control information.

In this case, the user can use the raising control information acquired from the other user, for at least one of only some of the steps in a raising step and some of a plurality of raising conditions to be provided simultaneously. On the other hand, for other steps and/or other conditions, the user can set raising control information based on, for example, at least one of his/her own judgment, his/her own rules of thumb, and a cloud's judgment. Note that it does not matter whether acquisition of raising control information is chargeable (acquired by purchase) or free (acquired by donation).

(6)

One communication terminal that controls one cultivation apparatus through the cloud may be able to purchase raising control information for another cultivation apparatus controlled by another communication terminal through the cloud. In this case, different prices are set for the purchased raising control information in accordance with at least one of a taste, a nutrient, an outer appearance, a size, a shape, a number of purchases, a repurchase rate, and a purchasing group of a harvest resulting from growth of a plant, as well as a number of purchases and a purchasing group of the raising control information.

By this, the price based on the evaluation of a harvest can be set. Note that the purchasing group includes general households, restaurants, researchers, and farmers. In addition, the price of raising control information is a consideration for the raising control information that is traded in at least one of cash and virtual currency.

(7)

The growth information transmitted from the cultivation apparatus may include a plurality of images of a plant controlled by one communication terminal, the images being obtained at different times in one growth process. In this case, an animation object formed of the plurality of images is created by the cloud and displayed on another communication terminal.

By this, the other user can check the current state of growth controlled by one user, in a very short period of time by an animation object. In addition, the animation object is created by the cloud and thus has no chance of being modified by the user. Accordingly, the reliability of data can be assured.

(8)

The other communication terminal may display animation objects of plants controlled by a plurality of communication terminals including the one communication terminal, such that the animation objects can be compared with each other.

By this, the user can highly efficiently check a plurality of current states of growth controlled by a plurality of other users, by their animation objects displayed such that the animation objects can be compared with each other.

Therefore, for example, when the user wants to purchase another user's raising control information, the user can efficiently access raising control information for obtaining excellent growth results.

(9)

The cultivation apparatus may include a lighting apparatus that irradiates the plant with a light, and the raising control information may include light irradiation control information of the lighting apparatus. In this case, the lighting apparatus is formed of lighting units, each including a light source and a board to which the light source is fixed, the board having a shape that allows extension by coupling to another board.

By the lighting units, a lighting apparatus can be formed that has a desired size and shape in accordance with a plant which is a light irradiation target and various circumstances of the cultivation apparatus where the lighting apparatus is mounted, and the like. Therefore, for example, excellent irradiation efficiency can be ensured and non-uniform irradiation can be prevented.

(10)

The cultivation system of the present invention may further include a near field communication apparatus having raising control information of the plant. In this case, the communication terminal receives the raising control information from the near field communication apparatus, and controls the cultivation apparatus through the cloud based on the received control information.

By this, raising control information can also be obtained without passing through the cloud. For example, raising control information which is applicable to the whole raising process can be efficiently learned and used in the cultivation system. In addition, for example, rare raising control information about a plant that is not originally accumulated in the cloud can be obtained from a near field communication apparatus and used in the cultivation system.

(11)

A cultivation program according to another aspect includes: a process by a cultivation apparatus of transmitting growth information to a cloud and receiving raising control information from the cloud; a process by the cloud of analyzing at least one of the growth information and the raising control information; and a process by a communication terminal of receiving a result of the analysis performed by the cloud and transmitting raising control information generated based on the result of the analysis to the cultivation apparatus through the cloud.

(12)

A cultivation method according to still another aspect includes: a step by a cultivation apparatus of transmitting growth information to a cloud and receiving raising control information from the cloud; a step by the cloud of analyzing at least one of the growth information and the raising control information; and a step by a communication terminal of receiving a result of the analysis performed by the cloud and transmitting raising control information generated based on the result of the analysis to the cultivation apparatus through the cloud.

By these cultivation program and cultivation method, growth information transmitted from a cultivation apparatus which is controlled by a user and raising control information transmitted to the cultivation apparatus are analyzed by the cloud. In addition, the results of the analysis of the growth information and the raising control information are given back in a mode where the user him/herself can use the results of the analysis, to control the cultivation apparatus in a system. By this, use of the cultivation system by the user is promoted, creating a virtuous cycle of creation of more useful plants.

### BRIEF DESCRIPTION OF THE DRAWINGS

FIG. 1 is a schematic diagram for describing a configuration of a basic outline of a cultivation system according to one embodiment.

FIG. 2 is a schematic diagram for describing an overall outline of the cultivation system of FIG. 1.

FIG. 3 is a schematic diagram showing an example of a cultivation apparatus.

FIG. 4 is a schematic front view of a lighting unit of a first embodiment.

FIG. 5 is a schematic front view showing a part of a lighting apparatus where a plurality of lighting units are coupled together.

FIG. 6 is a schematic front view of another example of the lighting unit of the first embodiment.

FIG. 7 is a schematic front view of still another example of the lighting unit of the first embodiment.

FIG. 8 is a schematic front view of yet another example of the lighting unit of the first embodiment.

FIG. 9 is a schematic front view showing a part of another example of the lighting apparatus.

FIG. 10 is a schematic front view showing a part of still another example of the lighting apparatus.

FIG. 11 is a schematic perspective view showing a part of yet another example of the lighting apparatus.

FIG. 12 is a schematic partially cutaway perspective view showing a part of another example of the lighting apparatus.

FIG. 13 is a flowchart showing an example of control of the cultivation system.

FIG. 14 is a schematic diagram showing an example of a display screen of a portable communication terminal.

FIG. 15 is a schematic diagram showing another example of the display screen of the portable communication terminal.

FIG. 16 is a schematic diagram showing still another example of the display screen of the portable communication terminal.

FIG. 17 is a flowchart showing an example of data mining of raising control information in a recording apparatus.

FIG. 18 is a flowchart for describing an example of using a near field communication apparatus.

FIG. 19 is a schematic diagram showing another example of the display screen of the portable communication terminal.

FIG. 20 is a schematic diagram showing an example of a market site map for raising control information.

### REFERENCE SIGNS LIST

100 cultivation system
200 portable communication terminal
300 cultivation apparatus
310 lighting apparatus
400 recording apparatus
500 cloud

### DESCRIPTION OF EMBODIMENTS

An embodiment of the present invention will be described below with reference to the drawings. In the following description, the same components are denoted by the same reference numerals. Their names and functions are also the same. Therefore, a detailed description thereof is not repeated.

### (Configuration Outline of a Cultivation System)

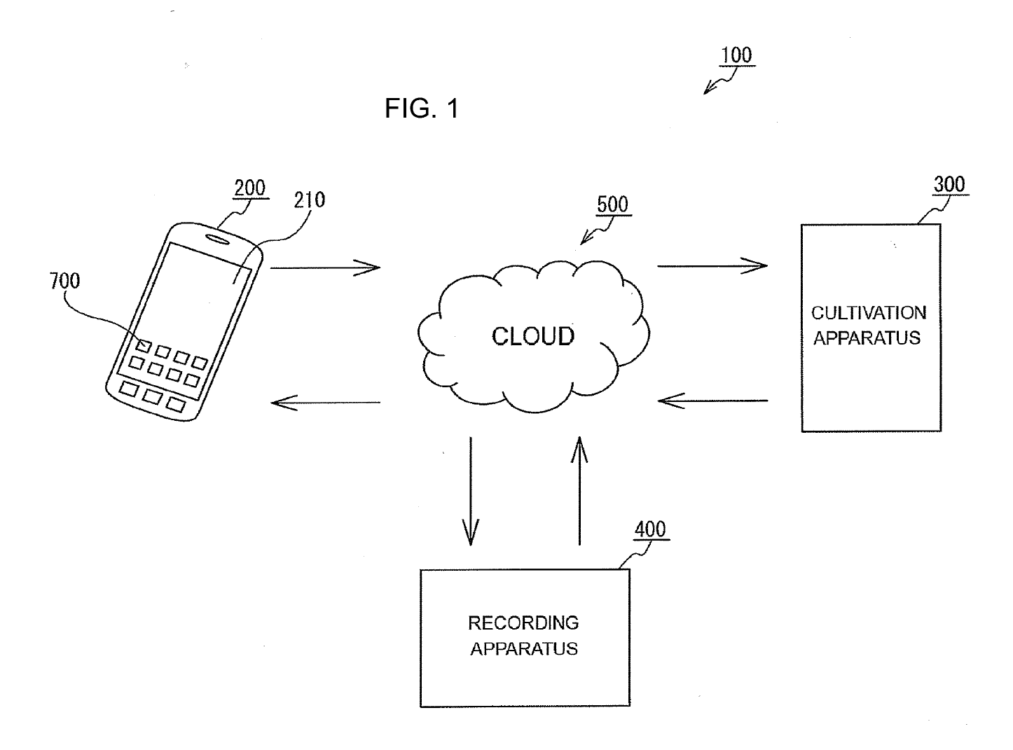

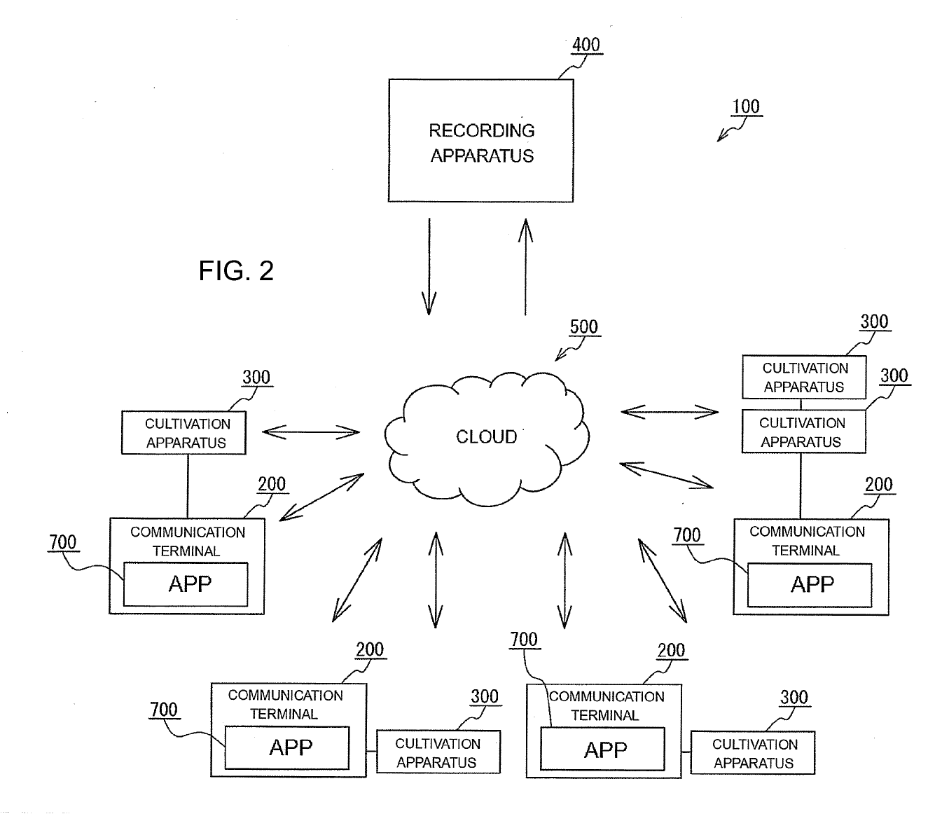

FIG. 1 is a schematic diagram for describing a configuration of a basic outline of a cultivation system 100 according to one embodiment, and FIG. 2 is a schematic diagram for describing an overall outline of the cultivation system 100 of FIG. 1.

As shown in FIG. 1, the cultivation system 100 includes a portable communication terminal 200, a cultivation apparatus 300, and a recording apparatus 400.

Application software (also referred to as an application program; hereinafter, simply abbreviated as an app) 700 is installed on the portable communication terminal 200. The app 700 is displayed as an icon on a display screen 210 before the app 700 starts. An icon badge may be displayed on the icon when information is received from a cloud 500 as will be described later. By starting the app 700, a user of the portable communication terminal 200 can raise plants by remotely controlling the cultivation apparatus 300 by his/her operations.

The cultivation apparatus 300 grows plants, transmits growth information to the cloud 500, and receives raising control information from the cloud 500. The cloud 500 analyzes the plant growth information transmitted from the cultivation apparatus 300.

The portable communication terminal 200 receives results of the analysis performed by the cloud 500. The communication terminal 200 transmits raising control information generated based on the results of the analysis to the cultivation apparatus 300 through the cloud 500. The raising control information transmitted to the cultivation apparatus 300 is also used for analysis to be performed by the cloud 500. The cultivation apparatus 300 controls various types of devices provided in the cultivation apparatus 300, in accordance with the raising control information received from the portable communication terminal 200, to raise the plants. The details of the various types of devices will be described later.

Information transmitted and received through the cloud 500 is recorded and accumulated in the recording apparatus 400 (which is present in the cloud 500). Therefore, the recording apparatus 400 records plant growth information and a moving status of the cultivation apparatus 300 which are transmitted from the cultivation apparatus 300 and records raising control information transmitted to the cultivation apparatus 300 from the portable communication terminal 200, whenever necessary. The growth information and raising control information recorded whenever necessary are accumulated as raising history information and control history information.

In the cultivation system 100, since information is transmitted and received through the cloud 500, even in the case of many access changes, the case can be easily handled.

Note that although FIG. 1 explicitly shows, for convenience, the case of growth in one cultivation apparatus 300, in the actual cultivation system 100, as shown in FIG. 2, there are multiple connections where a portable communication terminal 200 of a user and one or a plurality of cultivation apparatuses 300 owned by the user are connected to each other through the cloud 500.

By each of the users of the portable communication terminals 200 performing control of its cultivation apparatus 300 through the cloud 500 in the manner shown in FIG. 1, an enormous amount of information from various users which is transmitted and received through the cloud 500 is accumulated in the recording apparatus 400, as big data. The cloud 500 analyzes plant growth information which is transmitted from a cultivation apparatus 300 as occasion arises, and also analyzes growth history information and control history information using the big data, and transmits results of the analysis to a portable communication terminal 200, by which the results of the analysis are given back to a user of the portable communication terminal 200 in a mode where the user can easily use the results of the analysis in the cultivation system 100.

By giving back the results of the analysis performed by the cloud 500 to the user in such a mode, use of the cultivation system 100 by the user is promoted. As a result, for example, there can be expected promotion of the creation of harvests that can be harvested by outdoor cultivation or greenhouse cultivation but cannot be harvested at a so-called plant factory in the same manner (in terms of size, color, shape, species, reproducibility rate, and the like) and harvests that cannot be harvested by either outdoor cultivation or greenhouse cultivation (e.g., plants that contain a characteristic amount of a specific component useful in the medical, cosmetic, and health aid fields).

The plant growth information which is an example of an analysis target by the cloud 500 includes information about the current growth state and information about growth changes in a raising process.

The information about the current growth state includes information on, for example, the size, number, shape, and color of each organ (leaves, stems, flowers, fruits, and roots) of a plant, the status of nutrition contained in each organ, whether or not the plant has diseases or the degrees of diseases, and whether the plant has growth failure or the degree of growth failure. These pieces of information can be obtained by analyzing information sources such as image data of the plant and measurement data on the plant or an environment in the cultivation apparatus 300. The cloud 500 analyzes these pieces of information sources and transmits the results thereof as growth information to the communication terminal 200.

The information about growth changes in a raising process is derived as the amounts of changes in the above-described growth state. By this, the changes in the size, number, shape, and color of each part of the plant, the changes in the status of nutrition contained in each part, the progression or curing of diseases, the progression or curing of growth failure, and the amount of nourishment (such as water, carbon dioxide, and nourishment) taken up by the plant can be known.

These pieces of information analyzed by the cloud can be displayed, converted into a simple format so that general users that use the communication terminals 200 can easily grasp the information at a glance. Thus, even if the general users do not have expert knowledge on plants, they can easily handle growth information. Hence, the users can set, on their own, growth control information to be transmitted next to their cultivation apparatuses 300.

Note that the simple display format includes a format where the results of analysis are represented in a simplified manner by icons, text, numerical values, graphs, and the like.

The raising control information which is another example of an analysis target by the cloud 500 includes information about control conditions for each device provided in the cultivation apparatus 3300, timing at which control is performed, and timing at which control is canceled to end the raising (harvest). The cloud 500 analyzes growth information received from the cultivation apparatus 300, taking into consideration the growth information and raising control information which are already accumulated in the storage apparatus 400, and proposes, by automatic feedback, a raising control plan to be recommended next. Hence, the user can leave raising control information to be transmitted next to the cultivation apparatus 300 to a cloud's judgment.

### (Cultivation Apparatus)

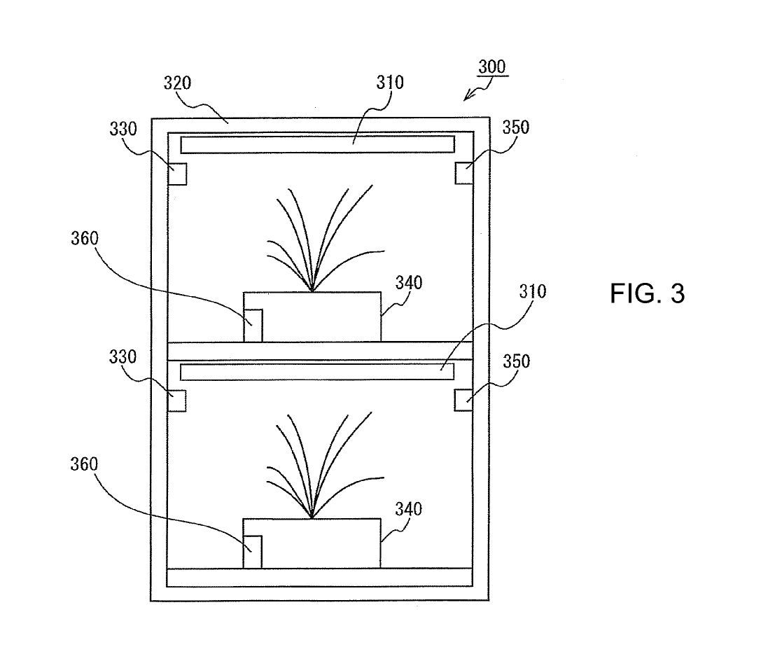

FIG. 3 is a schematic diagram showing an example of the cultivation apparatus 300.

As shown in FIG. 3, the cultivation apparatus 300 includes lighting apparatuses 310, a frame body 320, imaging apparatuses 330, cultivation containers 340, and environment control apparatuses 350 and 360.

The frame body 320 of the cultivation apparatus 300 has a structure that forms hermetically sealed spaces or open spaces, as cultivation spaces. The frame body 320 has cultivation spaces placed at the upper and lower levels, and one cultivation container 340 is disposed in each cultivation space. It is preferred that each cultivation space be blocked from sunlight.

Plants to be cultivated in the cultivation containers 340 include vegetables, flowers, grasses, fruits, and the like. The plants are not limited to those that are known to be able to be harvested at a so-called plant factory, but may be plants that can be harvested by outdoor cultivation or greenhouse cultivation but are unknown as to whether they can be harvested at a so-called plant factory in the same manner (in terms of size, color, shape, species, reproducibility rate, and the like) and plants that cannot be harvested by either outdoor cultivation or greenhouse cultivation (e.g., plants that contain a characteristic amount of a specific component useful in the medical, cosmetic, and health aid fields).

The lighting apparatuses 310, the imaging apparatuses 330, the cultivation containers 340, and the environment control apparatuses 350 and 360 can also be customized by the user selecting his/her desired types.

As shown in FIG. 3, the imaging apparatuses 330 are disposed in the cultivation spaces at the upper and lower levels, respectively. The imaging apparatuses 330 may be, for example, video cameras or digital cameras or may be infrared cameras, thermal imaging cameras, amount-of-photosynthesis measuring cameras, or other cameras that can measure growth. Images obtained by these cameras are recorded in the recording apparatus 400 in the cloud 500, and are automatically analyzed, by the cloud 500, qualitatively and/or quantitatively for the size, number, shape, and color of each organ (leaves, stems, flowers, fruits, and roots) of a plant, the status of nutrition contained in each organ, diseases, and growth failure. Results of the automatic analysis are recorded in the recording apparatus 400, and are given back to the user as a raising control plan or in a simple display format. Therefore, even users with no expert knowledge can use, for example, useful information about a growth state which is handled by experts such as researchers and producers (as expert information or as intuition).

The imaging apparatuses 330 can capture plant growth conditions continuously or at a predetermined interval.

The cultivation containers 340 are glass or plastic containers for hydroponic culture. For the cultivation containers 340, in addition to hydroponic culture containers, pots where artificial or natural soils are put, and the like may be selected as appropriate, depending on the species of plants to be cultivated, and the like.

The environment control apparatuses 350 are placed in gas phases in the cultivation spaces and measure, for example, the concentration of carbon dioxide, temperature, humidity, illumination, and micro-particulate matter. Furthermore, the environment control apparatuses 350 have a mechanism for controlling gas-phase components such as the concentration of carbon dioxide, temperature, humidity, and micro-particulate matter. Specifically, the environment control apparatuses 350 include a carbon dioxide concentration measuring apparatus and a carbon dioxide supplying apparatus, a thermometer and an air conditioner, a hygrometer and a humidifier and/or a dehumidifier, and an air cleaner.

In addition to the above, the environment control apparatuses 350 also include a blower fan that can control airflow.

The environment control apparatuses 360 are placed near root zones in the cultivation spaces and measure, for example, water temperature and in-water components. Furthermore, the environment control apparatuses 360 have a mechanism for controlling root zone environmental components such as water temperature and nourishment. Specifically, the environment control apparatuses 360 include a water temperature gauge and a water heater and/or a water cooler, an in-water component measuring apparatus and a nutrient solution supplying apparatus and/or an in-water component removing apparatus.

In addition to the above, the environment control apparatuses 360 also include a water flow generating apparatus that can control water flow.

As the environment control apparatuses 350 and 360, radiation dosimeters may be provided. In this case, an alarm may be transmitted to the portable communication terminal 200 when exceeding a predetermined dose.

Furthermore, a weighing scale may be provided in each cultivation space. In addition, an automatic harvester may be provided in each cultivation space.

For the lighting apparatuses 310, a light source may be selected from, for example, a light-emitting diode (hereinafter, simply abbreviated as an LED), organic electroluminescence, a high-pressure sodium lamp, a metal halide lamp, and a fluorescent lamp.

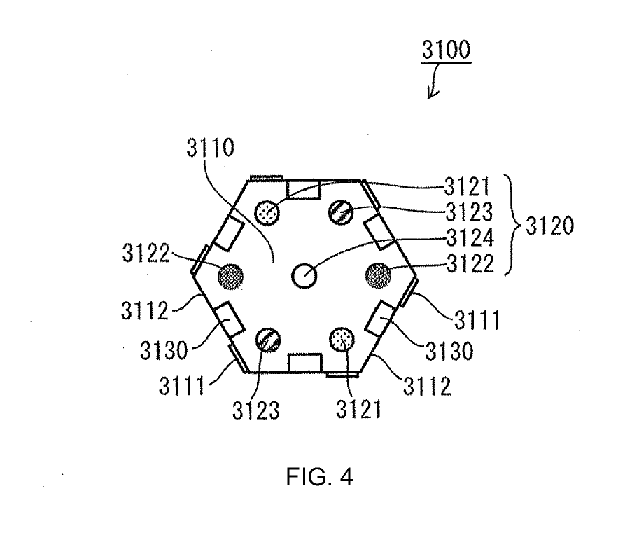

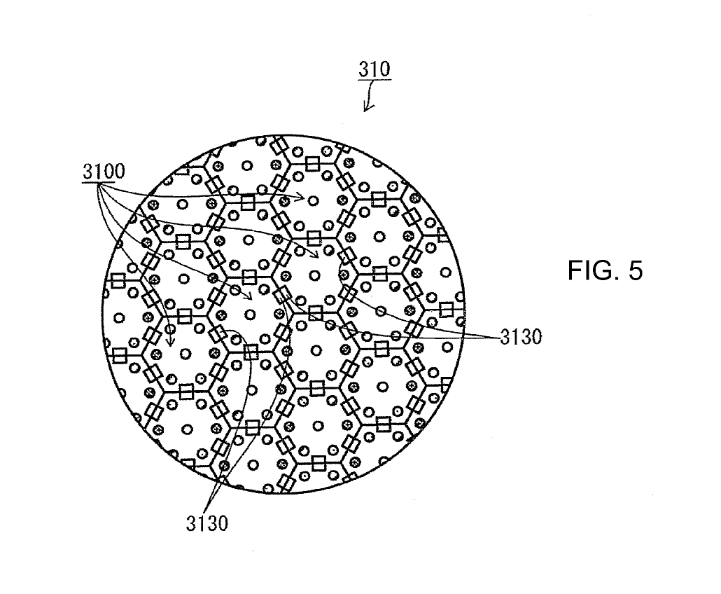

As an example of the lighting apparatus 310, the lighting apparatus 310 may be formed of a lighting unit 3100 shown in FIG. 4. FIG. 4 is a schematic front view of the lighting unit 3100. The lighting unit 3100 includes a board 3110 and LEDs 3120 mounted on the board 3110. FIG. 5 is a schematic front view of a lighting apparatus 310 formed by coupling a plurality of lighting units 3100 together for extension.

The board 3110 is a regular hexagonal rigid circuit board, flexible circuit board, or rigid-flex circuit board. The size of the board 3110 is such that one piece of the regular hexagon is 2.5 cm.

The materials of the board 3110 may include one selected as appropriate by a person skilled in the art from, for example, ceramics, synthetic resins, and metals. More specifically, composite materials such as a glass epoxy board and a glass composite board may be used. In addition, the board 3110 may be one having been subjected to a surface treatment process by application of a heat shield coating or the like, and a laminating process using an insulating layer or the like.

As the LEDs 3120, four types of single-colored LEDs, i.e., LEDs 3121, 3122, 3123, and 3124, are fixed to one side of the board 3110. For these LEDs, a surface mount LED where an LED device is mounted within a packaged material including an electrode is used. The dominant wavelengths of light emitted from the LEDs 3121, 3122, 3123, and 3124 differ from one another. Specifically, the LEDs 3121 emit a red light (hereinafter, abbreviated as the red LEDs 3121), the LEDs 3122 emit a blue light (hereinafter, abbreviated as the blue LEDs 3122), the LEDs 3123 emit an infrared light (hereinafter, abbreviated as the infrared LEDs 3123), and the LED 3124 emits a white light (hereinafter, abbreviated as the white LED 3124).

Two each of the red LEDs 3121, the blue LEDs 3122, and the infrared LEDs 3123, a total of six LEDs, are fixed to one board 3110. The six LEDs are all disposed at equal distances from the center of the board 3110, and are disposed near the respective vertices of the regular hexagon at regular intervals therebetween such that different types of LEDs are placed adjacent to each other. One white LED 3124 per board 3110 is disposed and fixed to the center of the board 3110.

It is known that the red light, the blue light, and the infrared light are perceived by specific receptors in plants. A correlation has been found between specific dominant wavelengths of light perceived by plant receptors and specific growth responses (e.g., biological responses that bring about photomorphogenisis including seed germination, flower differentiation, flowering, cotyledon expansion, chlorophyll synthesis, and internode elongation, and photosynthesis).

A terminal 3130 is provided at each side of the board 3100. Furthermore, a circuit of the board 3110 electrically connects between the terminals 3130 and packaged electrodes for the red LEDs 3121, the blue LEDs 3122, the infrared LEDs 3123, and the white LED 3124. The circuit and terminals 3130 of the board 3110 are designed such that the red LEDs 3121, the blue LEDs 3122, the infrared LEDs 3123, and the white LED 3124 can be controlled independently of each other. On the other hand, they may be designed such that LEDs of the same color can be controlled in conjunction with each other or may be designed such that LEDs of the same color can be controlled independently of each other.

The design that allows independent control is performed by providing control systems that correspond in type and/or number to LEDs to be controlled independently, such that the control systems function in parallel with each other.

As shown in FIG. 5, in the lighting units 3100, a board 3110 is coupled to other boards 3110 such that their sides butt against each other, forming a lighting apparatus 310. By the boards 3110 coupled to each other, the surfaces of the boards 3110 are two-dimensionally extended, resulting in a mode where the boards 3110 are laid out all over. Hence, the dispositions of the LEDs 3120 in the entire lighting apparatus 310 are desirably distributed, enabling to achieve uniformity of irradiating a light.

In this case, the terminals 3130 of a board 3110 are connected to terminals 3130 of other boards 3110. In order that the boards 3110 can be mechanically coupled to each other, a male coupling portion 3111 and a female coupling portion 3112 may be formed at each side. By this, a lighting unit 3100 and other lighting units 3100 are directly and electrically and mechanically coupled to each other.

The lighting units 3100 in the lighting apparatus 310 are all daisy-chain connected. Specifically, only two of the terminals 3130 provided to one lighting unit 3100 contribute to electrical and mechanical coupling. Those sides having other terminals 3130 are only mechanically coupled by male coupling portions 3111 and female coupling portions 3112.

In addition, one lighting apparatus 310 may have only one series circuit by a daisy-chain connection or may have a plurality of individually controllable series circuits.

The portable communication terminal 200 controls the red LEDs 3121, the blue LEDs 3122, the infrared LEDs 3123, and the white LEDs 3124 independently of each other. Meanwhile, LEDs of the same color may be controlled in conjunction with each other or may be controlled independently of each other.

In light source control, mainly, brightness is adjusted. Control of brightness is performed by changing a current value or a pulse width at 256 shades of gray (0 to 255). Specifically, for the purpose of adjusting flowering time, fruiting time, a plant form, nutritional components, and the like, using various plant's optical responses and reactions (growth responses), light of specific dominant wavelengths can be irradiated alone or in combination, depending on the species and growth stage of a plant, and the like.

In addition, when one lighting apparatus 310 has a plurality of series circuits, the portable communication terminal 200 can also control the series circuits independently of each other.

Control such as that described above is performed by a remote operation by the portable communication terminal 200 through the cloud 500.

### Other Examples

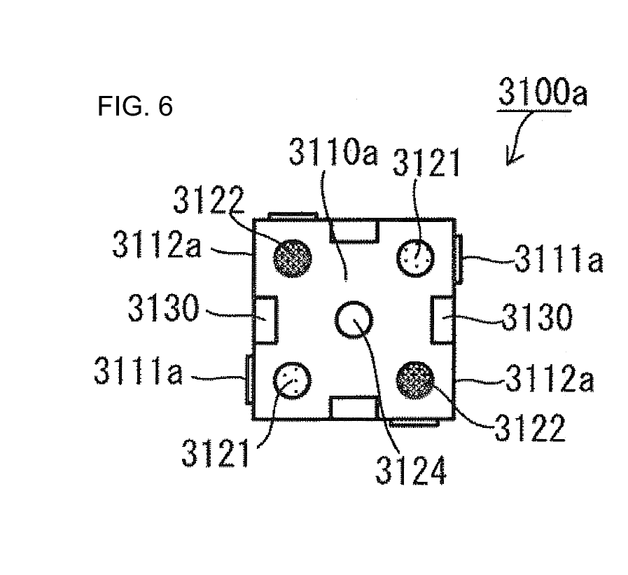

FIG. 6 is a schematic front view of a lighting unit 3100a which is another example of the lighting unit 3100. The lighting unit 3100a uses a square board 3110a instead of a regular hexagonal board 3110. Three types of single-colored LEDs, i.e., red LEDs 3121, blue LEDs 3122, and a white LED 3124, are fixed to one side of the board 3110a. Of them, two each of the red LEDs 3121 and the blue LEDs 3122, a total of four LEDs, are fixed to one board 3110a. The four LEDs are disposed near the respective vertices of the square at regular intervals therebetween such that different types of LEDs are placed adjacent to each other. One white LED 3124 per board 3110a is disposed and fixed to the center of the square.

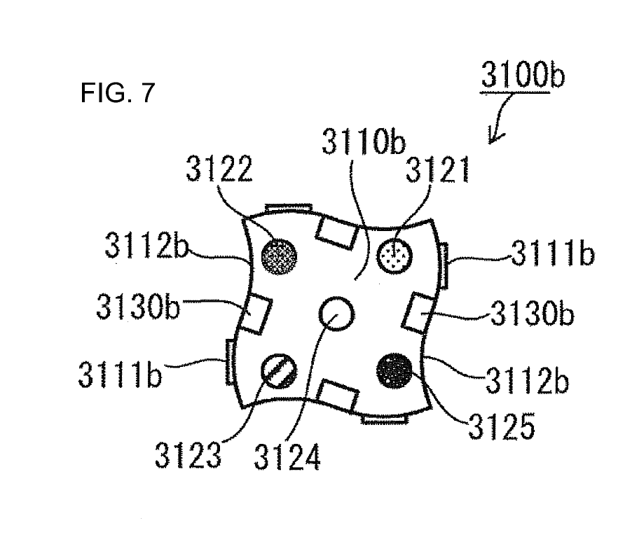

FIG. 7 is a schematic front view of a lighting unit 3100b which is still another example of the lighting unit 3100. The lighting unit 3100b uses a modified rectangular board 3110b whose outer edge is formed of four point-symmetrical curves of the same shape, instead of a regular hexagonal board 3110. Five types of single-colored LEDs, i.e., a red LED 3121, a blue LED 3122, an infrared LED 3123, a white LED 3124, and a green LED 3125, are fixed to one side of the board 3110b. A green light is also involved in plant growth responses as a red light, a blue light, and an infrared light do. One red LED 3121, one blue LED 3122, one infrared LED 3123, and one green LED 3125 per board 3110b are disposed near the respective vertices of the modified rectangle at regular intervals. One white LED 3124 per board 3110b is disposed and fixed to the center of the modified rectangle.

In addition, at the outer edge of the board 3110b are formed terminals 3130b that allow electrical and mechanical connections to other boards 3110b, and male coupling portions 3111b and female coupling portions 3112b that allow mechanical connections to other boards 3110b.

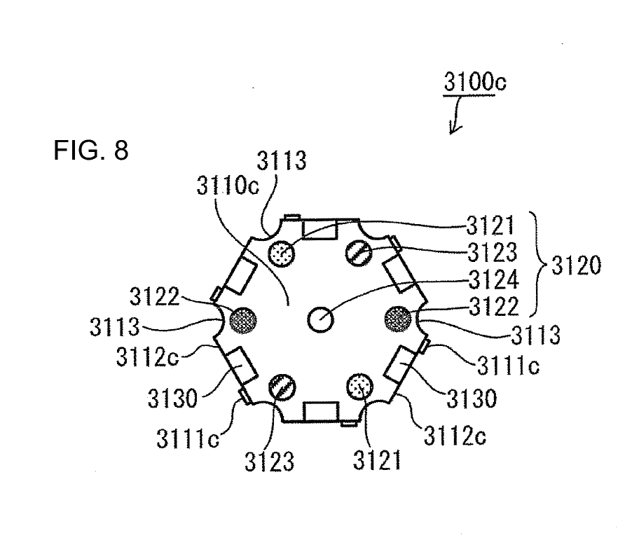

FIG. 8 is a schematic front view of a lighting unit 3100c which is yet another example of the lighting unit 3100. The lighting unit 3100c uses a board 3110c having recesses 3113, instead of a regular hexagonal board 3110. The recesses 3113 are provided at the respective vertex portions of the hexagon of the board 3110c.

In addition, at the outer edge of the board 3110c are formed male coupling portions 3111c and female coupling portions 3112c that allow mechanical connections to other boards 3110c.

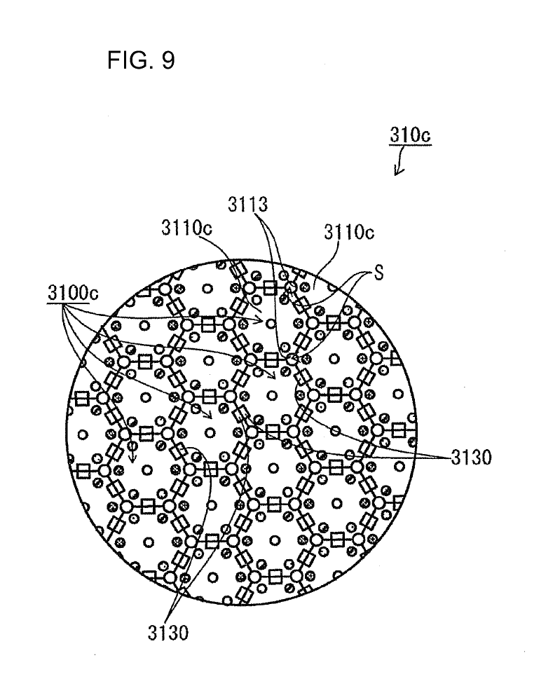

FIG. 9 is a schematic front view of a lighting apparatus 310c which is another example of the lighting apparatus 310. The lighting apparatus 310c is formed by coupling a plurality of lighting units 3100c together. In the lighting apparatus 310c, by coupling the plurality of boards 3110c together, openings S surrounded by the recesses 3113 formed at the boards 3110c are formed without the boards 3110c laid out all over the extended surfaces. The formation of such openings S may be preferable in some cases in terms of thermal release.

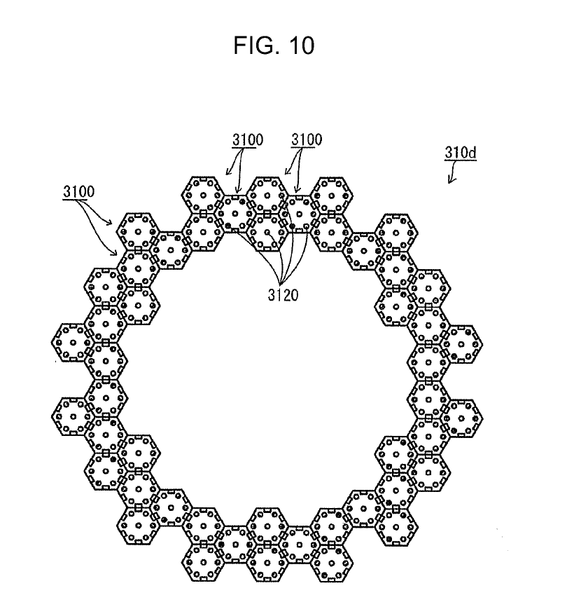

FIG. 10 is a schematic front view of a lighting apparatus 310d which is still another example of the lighting apparatus 310. The lighting apparatus 310d as a whole forms a ring shape by coupling a plurality of lighting units 3100 to each other.

By this, a wide-area irradiation can be performed with a smaller number of lighting units. In addition, as a similar mode, when a lighting apparatus is formed in a ring shape (or in a circular shape where the lighting units 3100 are laid out all over the interior of the circle) using a smaller number of lighting units 3100, a plant which is cultivated in a compact plant cultivation apparatus can be evenly irradiated.

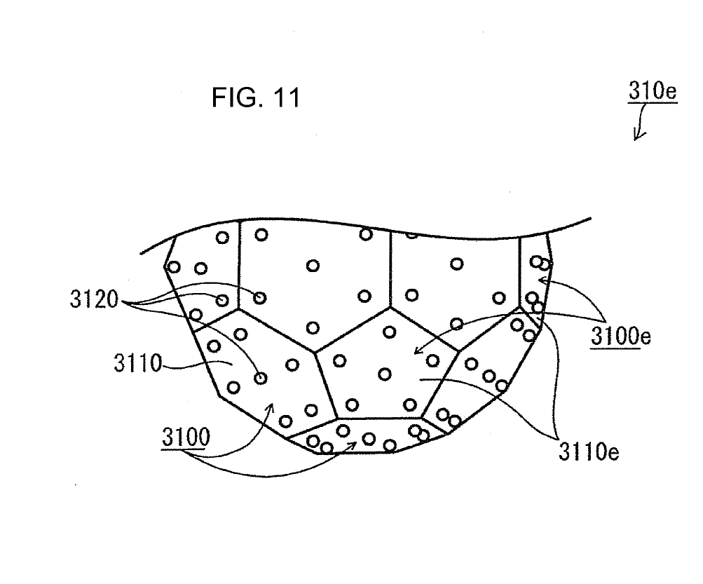

FIG. 11 is a schematic perspective view of a lighting apparatus 310e which is yet another example of the lighting apparatus 310. In the lighting apparatus 310e, lighting units 3100 and 3100e having boards 3110 and 3110e of different shapes are combined and coupled to each other. By this, the surfaces of the boards 3110 and 3110e are three-dimensionally extended, forming at least a part of a polyhedron (hereinafter, described as the planar structure). At this time, the planar structure is formed such that LEDs 3120 are fixed to a surface of an exterior of the planar, structure. By this, in the lighting apparatus 310e, the LEDs 3120 fixed to the surface of the exterior of the planar structure face in many directions on the exterior of the planar structure. Hence, even if LEDs with high directivity are used as the LEDs 3120, wide-area irradiation can be easily performed.

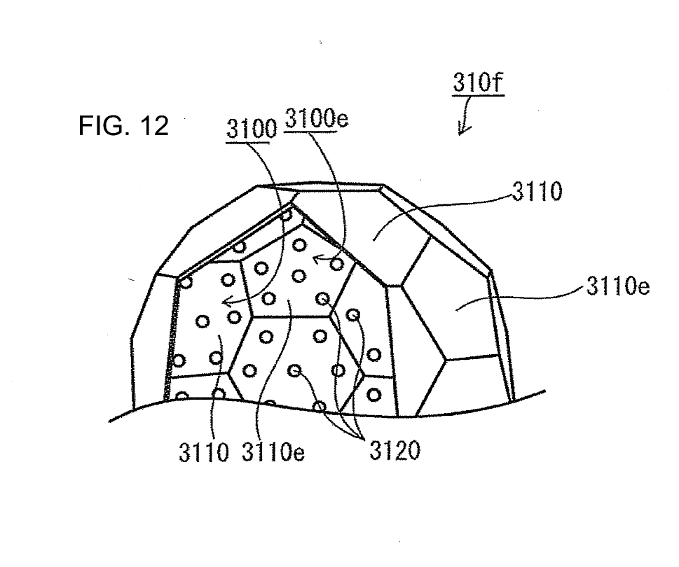

FIG. 12 is a schematic partially cutaway perspective view of a lighting apparatus 310f which is another example of the lighting apparatus 310. In the lighting apparatus 310f, lighting units 3100 and 3100e having boards 3110 and 3110e of different shapes are combined and coupled to each other. By this, the surfaces of the boards 3110 and 3110e are three-dimensionally extended, forming at least a part of a polyhedron (hereinafter, described as the planar structure). At this time, the planar structure is formed such that LEDs 3120 are fixed to a surface of an interior of the planar structure. By this, in the lighting apparatus 310f, all of the LEDs 3120 fixed to the surface of the interior of the planar structure face the interior of the planar structure. Therefore, by disposing a plant which is an irradiation target in the interior of the planar structure, the irradiation target is enclosed or covered, enabling to perform intensive irradiation. By forming the planar structure in a size close to the irradiation target, close irradiation can be evenly performed.

### [Variants]

In the above-described examples of lighting apparatuses, a square, a regular pentagon, and a regular hexagon are shown as the shapes of the boards 3110, 3110a, and 3100e, but other polygons, preferably regular polygons, may be used. In addition, the polygons may have any shape as long as the shape allows extension by coupling to each other, and it does not matter whether the polygons are convex or concave polygons.

Furthermore, although, in the above-described examples, a modified rectangular shape is shown as the shape of the board 3110b and a modified regular hexagon is shown as the shape of the board 3110c, other modified polygons may be used. The modified polygons include a shape formed by connecting the vertices of a polygon by curves instead of straight lines, and a polygon where each cutting portion is formed at a part of the polygon.

Although, in the above-described examples, an example is shown where the recesses 3113 are formed as depressions at the vertices of the regular polygon (regular hexagon) of the board 3110c, the position and shape on the board of the recesses 3113 are not limited thereto. For example, the recesses 3113 may be through-holes provided within the board or may be depressions formed at edges other than the vertices of the shape of the board. For example, a concave polygon is an example of the shape of a board having recesses. When a board having recesses is used, by coupling a plurality of such boards together, openings are logically formed without the boards laid out all over the extended surfaces. The formation of such openings may be preferable in some cases in terms of thermal release and the like.

Although, in the above-described examples, the surface mount LEDs are shown as the LEDs 3120, cannonball-shaped LEDs or LEDs of any other shape may be used. In addition, although, as a fixing method, a mode where the LEDs are directly mounted on the surface of the board is shown, the fixing mode for the LEDs 3120 may be a removable mode, e.g., a mode that uses a socket.

Although, in the above-described examples, single-colored light sources are shown as light sources, it does not matter whether the light sources are single-colored light sources or multi-colored light sources. While, in the single-colored light sources, a light of color that can be produced by one light source has one type of dominant wavelength, in the multi-colored light sources, a light of color that can be produced by one light source has multiple dominant wavelengths. Control of the dominant wavelengths emitted by the multi-colored light source is performed as appropriate by a person skilled in the art.

Some or all of the light sources fixed onto the board may be multi-colored light sources. When all of the light sources fixed onto the board are multi-colored light sources, control is performed such that at least two light sources emit at least light of different dominant wavelengths independently of each other. Specifically, the dominant wavelengths of light emitted from each of the light sources to be controlled independently of each other or the dominant wavelengths and brightness levels are controlled.

By this, for example, as shown in FIGS. 4, 6, 7, and 8, the light having a plurality of dominant wavelengths can be produced within one lighting unit.

In addition, the number of light sources fixed to the board is not limited to those in the above-described examples. Specifically, though the number may vary due to a factor such as the surface area of the board, the number is, for example, between 2 and 20, inclusive, between 2 and 15, inclusive, or between 2 and 10, inclusive.

The surface area of one board is not particularly limited, either, but is, for example, 150 cm² or less. An upper limit included in the range may be 130 cm², 100 cm², 50 cm², 30 cm², 15 cm², 10 cm², or 5 cm². A lower limit included in the range is not particularly limited, but may be, for example, 1 cm², 5 cm², 10 cm², 15 cm², 30 cm², 50 cm², 100 cm², or 130 cm². A lighting unit with a smaller board surface area has greater flexibility upon forming a lighting apparatus and thus is preferable. For example, the outer rim and/or inner rim of a specific planar shape such as the ring shape exemplified in FIG. 10 can be formed to be closer to a smooth curve. In addition, the outer surface of a specific three-dimensional shape exemplified in FIG. 11 and the inner surface of a specific three-dimensional shape exemplified in FIG. 12 can be formed to be closer to a smooth curve. Furthermore, it becomes easier to form a planar shape having a complex outer rim with projections and depressions and/or a complex inner rim with projections and depressions or a three-dimensional shape having a complex surface with projections and depressions.

The pitch at which the light sources fixed to the board are disposed is not particularly limited, either. Specifically, though the pitch may vary depending on the size of the light sources, it is preferred that the average of the shortest center-to-center distances between adjacent light sources in a lighting unit or in the entire lighting apparatus be, for example, less than or equal to 5 times, less than or equal to 3 times, less than or equal to 2 times, less than or equal to 1.5 times, or less than or equal to 1.3 times the largest diameter of the light sources. A lower limit included in the range is not particularly limited, but is, for example, the same length as the largest diameter of the light sources.

Here, the shortest center-to-center distance between light sources is the distance connecting the centers of one light source and one of other light sources adjacent to the one light source that is present closest to the one light source. In the lighting apparatus, the one light source and the other adjacent light sources may be both present within the same lighting unit or may be present within different adjacent lighting units. In addition, the largest diameter of the light sources is the largest diameter in a direction parallel to the board surface.

Alternatively, the average value of the shortest center-to-center distance between adjacent light sources in a lighting unit or in the entire lighting apparatus may be 50 mm or less, 30 mm or less, 20 mm or less, 10 mm or less, or 5 mm or less. In some cases, a smaller lower limit included in the range may be preferable. The lower limit is not particularly limited, but is, for example, 0.1 mm.

Furthermore, it is preferred that the distributions of the dispositions of light sources be nearly uniform in the entire lighting apparatus. That is, it is preferred that the light sources be disposed such that light of different dominant wavelengths emitted from the light sources of the lighting apparatus are mixed with each other on an irradiation target surface. Specifically, it is more preferable that all of the shortest center-to-center distances between light sources be the same in the entire lighting apparatus. That is, it is most preferable that the standard deviation of the shortest center-to-center distances between light sources in the entire lighting apparatus be 0, and it is preferable that the standard deviation be close to 0.

For example, in the entire lighting apparatus, the ratio of the largest value of the shortest center-to-center distance to the smallest value of the shortest center-to-center distance (the largest value of the shortest center-to-center distance/the smallest value of the shortest center-to-center distance) is between 1 and 1.5, inclusive, preferably between 1 and 1.3, inclusive, and more preferably between 1 and 1.2, inclusive.

By this, uniformalization of light of a plurality of different dominant wavelengths can be achieved. By the uniformalization of light, growth reproducibility for when plant growth is controlled under the same conditions can be improved.

Although, in the above-described examples, a daisy-chain connection is shown as an electrical connection between the lighting units 3100, 3100c, and 3100e in the lighting apparatuses 310, 310c, 310d, 310e, and 310f, the electrical connection may be a star connection.

Although, in the above-described examples, as the planar structure of the lighting apparatuses 310e and 310f, one that is formed by a combination of the lighting units 3100 and 3100e having the boards 3110 and 3110e of a plurality of shapes is shown, the planar structure may be formed of lighting units having boards of the same shape.

By the lighting units 3100, 3100a, 3100b, 3100c, and 3100e, the following advantageous effects are provided.

In the lighting units 3100, 3100a, 3100b, 3100c, and 3100e, one lighting unit 3100 includes a plurality of types of LEDs 3120 that emit light of different dominant wavelengths, and the boards 3110, 3110a, 3110b, 3110c, and 3110e are extendable. Thus, by coupling a plurality of lighting units 3100, 3100a, 3100b, 3100c, and 3100e together, a lighting apparatus can be formed that has a desired size and shape, in accordance with a plant and/or various circumstances such as a plant growth location.

In addition, since the boards 3110, 3110a, and 3110e are polygonal, the shapes of the lighting units 3100, 3100a, and 3100e can be simplified, and thus, extension of the lighting units 3100, 3100a, and 3100e can also be performed easily.

In particular, since the board 3100 is hexagonal and the board 3100c is modified regular hexagonal, a high degree of flexibility can be obtained in the shapes of the lighting apparatuses 310, 310c, and 310d which are formed by extension of the lighting units 3100.

In the lighting units 3100, 3100a, 3100b, 3100c, and 3100e, the LEDs 3120 emit a light selected from a red light, a blue light, a green light, and an infrared light, and thus, can be suitably applied to plant growth applications. In addition, by using the white LED 3124, it becomes easier to identify the color of a plant being grown.

In the lighting units 3100, 3100a, 3100b, 3100c, and 3100e, the brightness of a plurality of types of LEDs 3120 are individually controlled. Thus, it becomes easier to irradiate colors of various patterns, in accordance with the species and/or growth stage of a plant.

Since the lighting units 3100, 3100a, 3100b, 3100c, and 3100e use the LEDs 3120 as light sources, the energy saving and lifespan extension of the lighting units 3100, 3100a, 3100b, 3100c, and 3100e can be achieved.

Since, in the lighting apparatuses 310, 310c, 310d, 310e, and 310f, the lighting units 3100, 3100c, and 3100e are daisy-chain connected to each other, an electrical path can be simplified.

In the lighting apparatuses 310e and 310f, the boards 3110 and 3110e have different shapes. Thus, a high degree of flexibility in shape is obtained by combining the lighting units 3100 and 3100e for extension.

### (Basic Program for the Cultivation System)

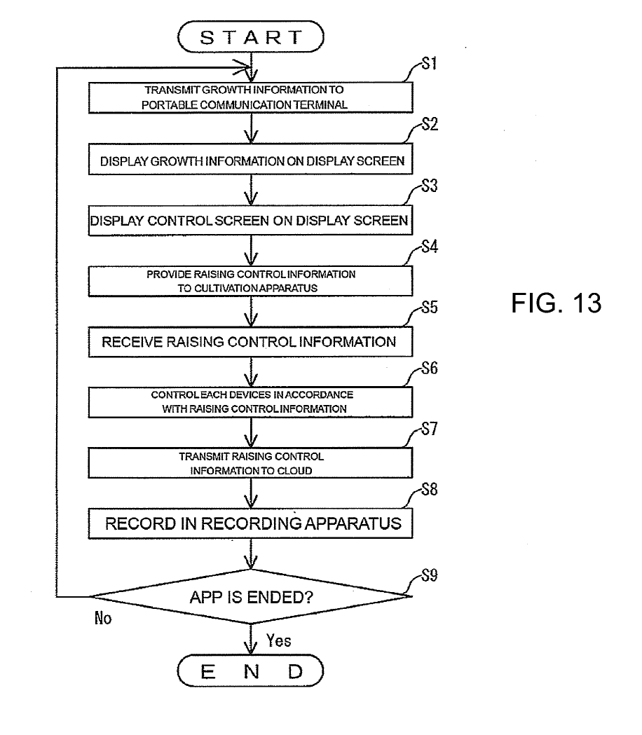

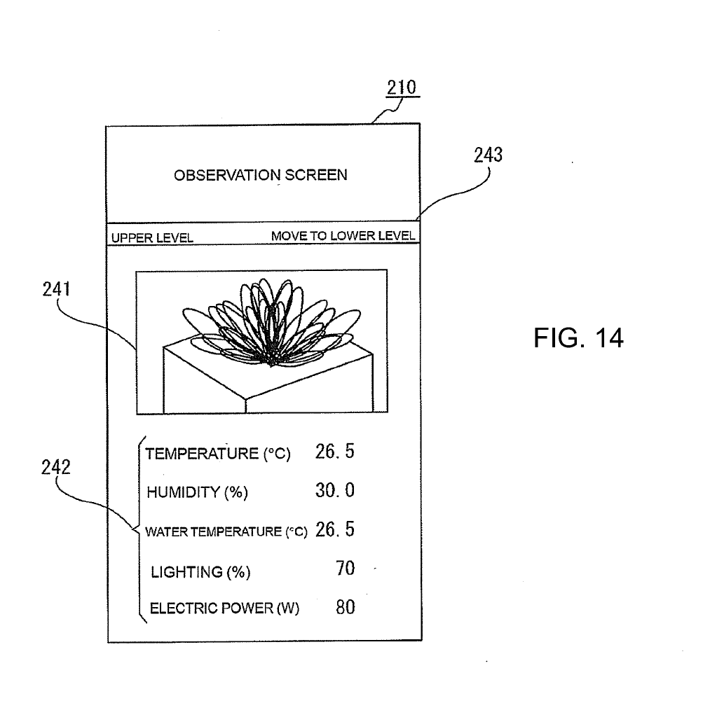

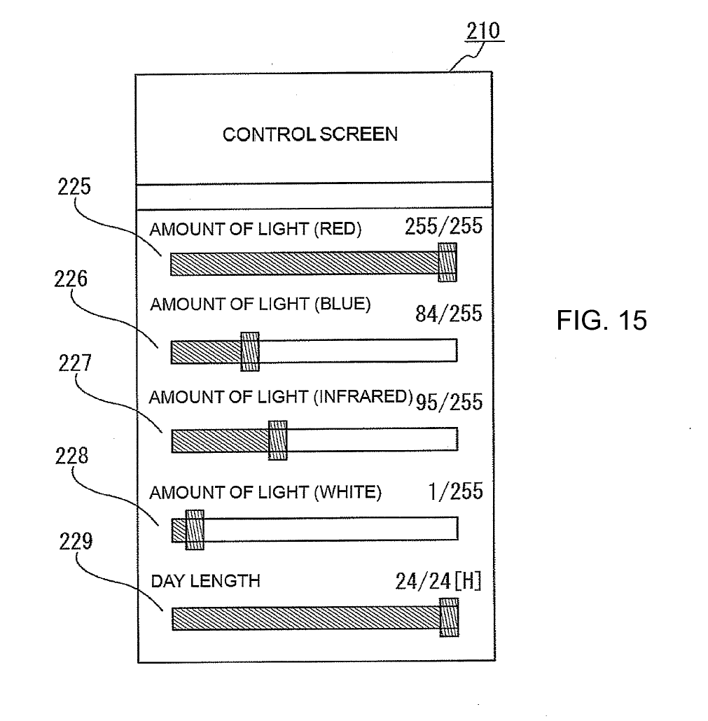

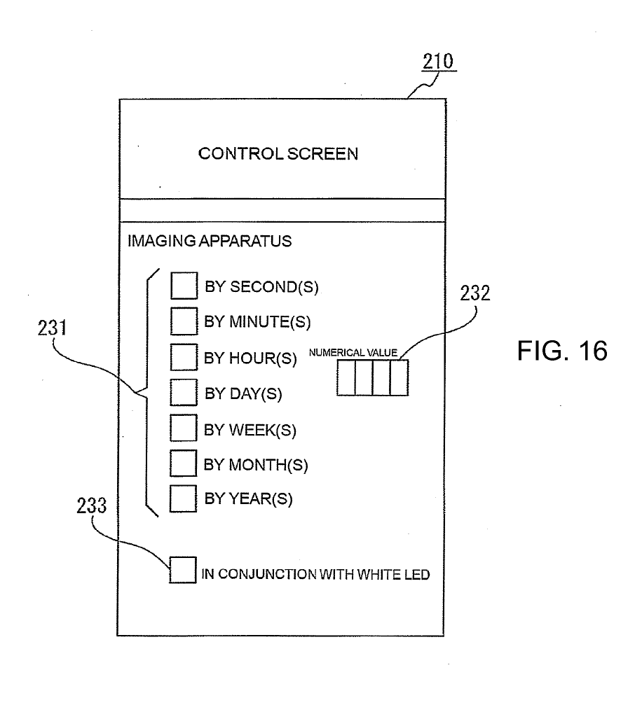

Next, an outline of the operation of the cultivation system will be described. First, FIG. 13 is a flowchart showing an example of control of the cultivation system 100. In addition, FIG. 14 is a schematic diagram showing an example of the display screen 210 of the portable communication terminal 200, FIG. 15 is a schematic diagram showing another example of the display screen 210 of the portable communication terminal 200, and FIG. 16 is a schematic diagram showing still another example of the display screen 210 of the portable communication terminal 200.

When a user starts the app 700 on the display screen 210 of the portable communication terminal 200 which is shown in FIG. 1, processing starts as shown in FIG. 13.

First, growth information about the current states of plants is transmitted to the portable communication terminal 200 from the cultivation apparatus 300 through the cloud 500 (step S1). The growth information transmitted to the cloud 500 from the cultivation apparatus 300 and the growth information transmitted to the portable communication terminal 200 from the cloud 500 are recorded in the recording apparatus 400.

The portable communication terminal 200 displays the received plant growth information on the display screen 210 (step S2).

For example, as shown in FIG. 14, an observation screen is displayed on the display screen 210 of the portable communication terminal 200. On the display screen 210 of FIG. 14 are displayed an image 241 of a plant at the upper level and the current measurement results 242 of the environment control apparatuses 350 and 360.

In addition, by selecting a screen change command 243, the information can be changed to information on a plant at the lower level. By selecting the image 241, image data for the last one day, the last one week, and the last one month is continuously displayed, by which the user can observe how the plant grows, in a short period of time. In addition, when the image 241 is moving image data, fast-forward playback, pause playback, and the like can be selected.

The measurement results of the environment control apparatuses 350 and 360 may be only the current ones as shown in FIG. 14, or may be ones displayed in a time course based on the past measurement results (e.g., simple display such as display in graph form). By this, the user can easily grasp changes in environment. The measurement results of the environment control apparatuses 350 and 360 are displayed as automatic analysis results obtained by the cloud 500.

Furthermore, on the display screen 210 of FIG. 14, an icon that allows to access a raising control plan which is presented by the cloud 500 may be displayed. One or a plurality of raising control plans may be presented. When a plurality of raising control plans are presented, a plurality of plant growth states may be assumed and raising control plans which are recommended to guide to the respective assumed growth states may be presented. By the user selecting the presented raising control plan, he/she can determine raising control information for performing the processes at and after step S3 which will be described later.

Instead of or in addition to the above-described raising control plan, an icon that allows to access a market site which will be described later may be displayed. By the user purchasing raising control information from the market site, he/she can determine raising control information for performing the processes at and after step S3 which will be described later.

Furthermore, in addition to the image 241 shown in FIG. 14, automatic analysis results obtained by the cloud 500 may be displayed (preferably, simple display). By this, the user grasps growth conditions and thus can judge and determine, on his/her own, raising control information for performing the processes at and after step S3 which will be described later.

In the above-described manner, the user checks the display screen 210 of the portable communication terminal 200, grasps the plant growth conditions, and determines raising control information.

Note that in the cultivation system 100 the user can select full manual mode, full auto mode, or hybrid mode to determine raising control information.

In full manual mode, the user determines all raising control information on his/her own in all steps in the raising process. Therefore, user's original raising control information is constructed. In this case, the setting can be performed not to display a raising control plan provided by the cloud 500.

In full auto mode, the user leaves all raising control information to raising control plans provided by the cloud 500 or purchased raising control information, in all steps in the raising process. Therefore, already constructed raising control information is regenerated.

In hybrid mode, the user can arbitrarily combine raising control information that is determined by his/her own judgment, a raising control plan presented by the cloud 500, and purchased raising control information, as raising control information to instruct. Therefore, pieces of raising control information which are determined by different techniques are used for some steps in the raising process and/or for some of a plurality of pieces of raising control information which are simultaneously transmitted. By this, an enormous number of variations of raising control information are newly constructed from already constructed raising control information.

Upon determining raising control information, for example, as shown in FIG. 15, a control screen is displayed on the display screen 210 (step S3).

As shown in FIG. 13, the portable communication terminal 200 adjusts the raising control conditions to desired ones by operating the control screen, and/or permits raising control conditions which are automatically adjusted on the control screen, and provides the raising control information to the cultivation apparatus 300 via the cloud 500 (step S4).

The cultivation apparatus 300 receives the instruction from the portable communication terminal 200 (step S5). The cultivation apparatus 300 controls the lighting apparatus 310, the imaging apparatus 330, and the environment control apparatuses 350 and 360, in accordance with the raising control information (step S6).

Now, a specific example of the processes at steps S3 to S6 will be described. For example, as shown in FIG. 15, when the settings of the lighting apparatus 310 of the cultivation apparatus 300 are controlled, an adjustment of the red LEDs 3121 is performed by an adjusting unit 225, an adjustment of the blue LEDs 3122 is performed by an adjusting unit 226, an adjustment of the infrared LEDs 3123 is performed by an adjusting unit 227, an adjustment of the white LEDs 3124 is performed by an adjusting unit 228, and one day irradiation time is performed by an adjusting unit 229.

In addition, as shown in FIG. 16, the settings of the imaging apparatus 330 on the display screen 210 include selection boxes 231 for selecting the unit of seconds, the unit of minutes, the unit of hours, the unit of days, the unit of weeks, the unit of months, and the unit of years; an input box 232 for inputting a numerical value for each unit; and a check box 233 asking whether to allow the white LEDs 3124 to emit a light in conjunction with imaging timing.

The conjunction light-up of the white LEDs 3124 is preferable in terms of that the color of the plant can be accurately captured when image data is captured.

For example, when “1” is inputted to the input box 232 and the “unit of seconds” selection box is checked, capturing is performed every second. When “3” is inputted to the input box 232 and the “unit of minutes” selection box is checked, capturing is performed every three minutes.

The cultivation apparatus 300 controls the imaging apparatus 330, in accordance with the raising control information instructed on the display screen 210 of FIG. 16.

Note that image data is not limited to one obtained by capturing at a predetermined interval, and may be moving image data which is shot continuously.

In addition, the app 700 on the portable communication terminal 200 can also display, on the display screen 210, a control screen for controlling the environment control apparatuses 350 and 360. In this case, specific content on the display screen 210 can be determined as appropriate by a person skilled in the art, according to FIG. 15, and thus, a description thereof is omitted. The cultivation apparatus 300 controls the environment control apparatuses 350 and 360, in accordance with the raising control information instructed on the display screen 210.

The above-described raising control information is individually transmitted to each of the cultivation spaces disposed at the upper and lower levels of the cultivation apparatus 300, by which the cultivation spaces can be controlled independently of each other.

The portable communication terminal 200 transmits the raising control information to the cultivation apparatus 300 through the cloud 500 (step S7), and all of the raising control information transmitted to the cultivation apparatus 300 is recorded in the recording apparatus 400 (step S8).

Furthermore, the conditions of the cultivation apparatus 300 after the transmission of the raising control information may be checked in the same manner as at steps S1 and S2.

Finally, as shown in FIG. 13, it is determined whether the app 700 on the portable communication terminal 200 has ended (step S9). If it is determined that the app 700 has not ended, processing is repeated again from the process at step S1. On the other hand, if it is determined that the app 700 has ended, processing ends.

### (Data Mining of Raising Control Information)

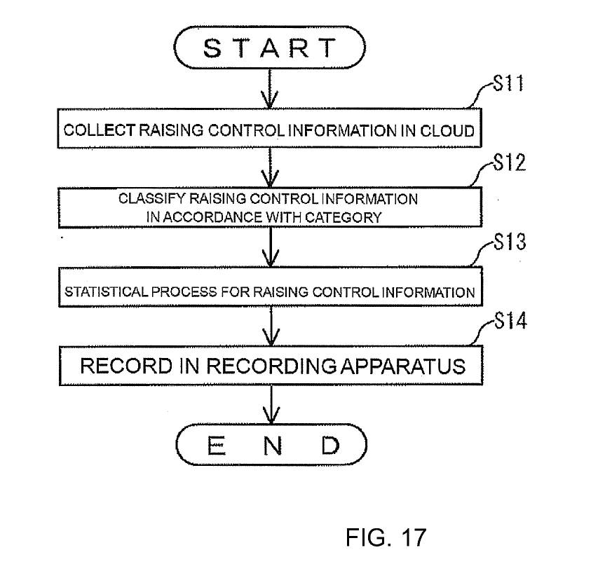

In analysis performed by the cloud 500, data mining is performed on the raising control information recorded in the recording apparatus 400. FIG. 17 is a flowchart showing an example of data mining of raising control information in the recording apparatus 400.

As shown in FIG. 17, raising control information recorded in the recording apparatus 400 in the cloud 500 is collected (step S11).

The collected raising control information is classified in accordance with its track record by categories: the species of the plant, the growth stage of the plant, and the final form of the plant (step S12).

Examples of the category of the species of the plant include, as a large category, vegetables, fruits, grasses, trees, flowers, and the like, and include, as a small category, cabbages, lettuces, red leaf lettuces, and the like. Examples of the category of the growth stage of the plant include a planting stage, a seedling stage, a growing stage, a harvesting stage, and the like. Examples of the category of the final form of the plant include the size, shape, color, and components (nutrients such as sugars and acids) of a harvest. In addition to or instead of the category by the components, classification may be done by preferences (tastes such as sweetness, sourness, bitterness, pungency, and astringency, smell, and the like).

Then, a statistical process, e.g., optimization, for the raising control information classified by the categories is performed (step S13). Note that a technique for the statistical process is not limited thereto, and averaging or other statistical processing methods may be arbitrarily performed.

Results of the data mining are recorded as results of analysis of the raising control information in the recording apparatus 400 through the cloud 500 (step S14).

(Read Raising Control Information from a Near Field Communication Apparatus)

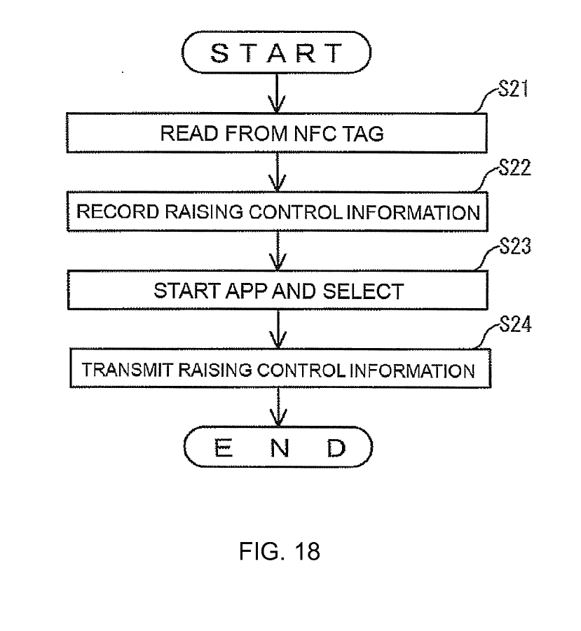

FIG. 18 is a flowchart describing an example of using a near field communication apparatus in the cultivation system 100.

For example, NFC (Near field communication) tags which are near field communication apparatuses are attached to, for example, shelves in a store that sells seeds and seedlings of plants, or bags of the seeds and seedlings of plants.

In this case, each NFC tag has recorded therein raising control information about a seed or a seedling that is placed on a display shelf or in a bag.

When the user purchases a seed or a seedling, he/she reads an attached NFC tag by the portable communication terminal 200 (step S21). Then, growth control information is recorded in the portable communication terminal 200 (step S22).

Then, the user starts the app 700 and selects the raising control information (step S23).

Finally, the raising control information is transmitted to the cultivation apparatus 300 where the purchased seed or seedling is planted (step S24), by which growth can be performed. In this case, the user may regenerate all of the purchased raising control information in full auto mode or may modify a part of the raising control information in hybrid mode.

In addition to the above, the NFC tag may have recorded therein an address for accessing the raising control information. In this case, the user can acquire the raising control information by obtaining the address and accessing the address.

Furthermore, in addition to the above, when an NFC communication apparatus is mounted on the portable communication terminal 200, the raising control information may be transmitted and received between users.

### (Viewing of Other Users' Growth Information and Raising Control Information)

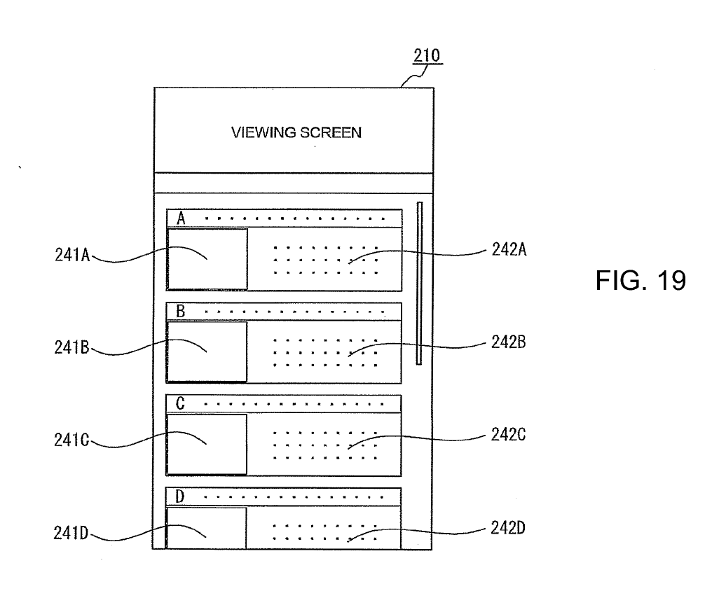

FIG. 19 shows an example of the display screen 210 of the portable communication terminal 200 for when the user views other users' growth information and raising control information in the cultivation system 100.

On the display screen 210 are displayed pieces of growth information of plants in cultivation apparatuses 300 that are controlled by a plurality of users A, B, C, and D, using their portable communication terminals 200. For the growth information, for example, an image 241A of a plant raised by the user A and measurement results 242A are displayed. The same display is provided for other users, too.

In this case, the image 241A of the plant is displayed as a GIF animation object where a plurality of images obtained at different times in the raising process are displayed frame by frame in chronological order. The number of images forming the GIF animation object is, for example, between 4 and 8, inclusive, preferably between 5 and 7, inclusive, and 6 as an example. The last image displayed in chronological order is the latest image. The image 241A is created by the cloud 500 processing image data which is received by the cloud 500 from the cultivation apparatus 300, and thus, has no chance of being modified by the user. Such a GIF animation object is displayed in the same manner for other users, too, and the GIF animation objects are displayed side by side so that they can be compared with each other. Hence, while the user compares how the plants have been grown by which users up to the present time, the user can easily and efficiently grasp them.

By the user selecting, on the display screen 210 of FIG. 19, a display portion of data that the user has determined that the plant is desirably raised, the user can access and acquire raising control information that is instructed by another user to raise in such a manner.

### (Provision and Acquisition of Raising Control Information)

It does not matter whether raising control information is chargeable or free.

A user that provides raising control information him/herself can select whether it is chargeable or free.

Alternatively, raising control information may be free at the beginning of its provision, and the raising control information may be used by other users in full regeneration mode. In this case, a raising process and/or a harvest brought about by the raising control information are evaluated by the other users in full regeneration mode. Then, on the condition that a certain criterion (e.g., a predetermined number of positive evaluations are obtained) is met, the raising control information can be charged. By this, the reliability of chargeable raising control information can be assured.

Furthermore, the user can also select whether to allow other users to modify the provided raising control information.

The user may declare that his/her raising control information may be disclosed to a large number of other unspecified users, or in order that the raising control information can only be disclosed to specific other users, the user may set a password that the other users can know in a strictly confidential manner.

When the raising control information is chargeable, the price may be set in accordance with various conditions.

The conditions that differentiate the price include evaluation track records such as the taste, nutrients, outer appearance, size, and shape of a harvest raised using the raising control information. These conditions are ranked, and different prices can be set in accordance with the ranks. Note that the evaluation may be obtained by performing a statistical process, such as averaging, on users' subjective evaluations, may be performed fairly by an evaluation organization, or may be automatically performed by the cloud 500 from analysis of image data which is obtained from the cultivation apparatus 300.

In addition, the conditions that differentiate the price also include purchasing track records such as the number of purchases, repurchase rate, purchasing group, and the like of a harvest raised using the raising control information, and the number of purchases and purchasing group of the raising control information itself. For example, the price can be set such that the higher the number of purchases and/or the repurchase rate, the higher the price. The purchasing group includes general households, restaurants, researchers, farmers, and the like. For example, the price can be such that information that is purchased by a general household has a lower price, information that is purchased by a fine dining restaurant among restaurants, e.g., a luxurious traditional Japanese restaurant, has a higher price, and rare information, for example, that is purchased by a researcher has a higher price.

In addition, the raising control information may be traded in at least one of cash and virtual currency. The virtual currency may be points that can be obtained by a user according to the track record of use of the cultivation system 100, the track record of purchase of raising control information, the track record of free-of-charge provision of raising control information to other users, and the like.

In addition, it is also possible to make raising control information where a certain period of time has elapsed since its first provision to the cultivation system 100, available for free as a public domain. By this, a search for new raising control conditions is induced by users, enabling to efficiently improve plant raising techniques.

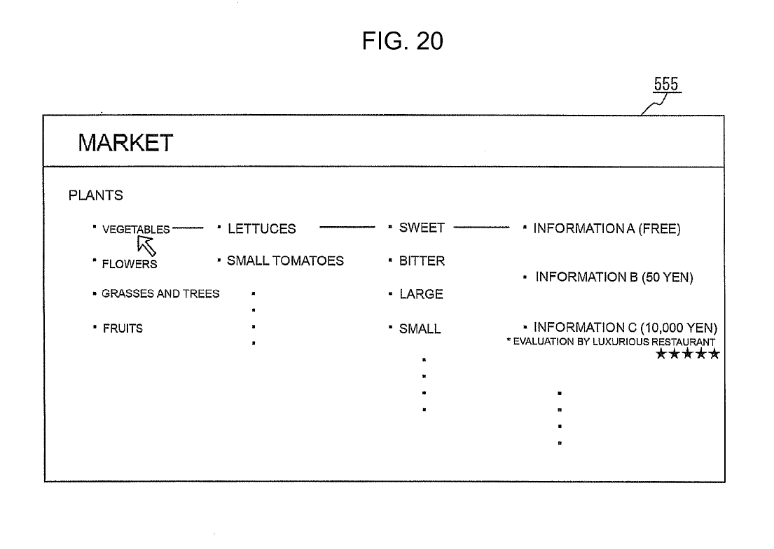

FIG. 20 is a schematic diagram showing an example of a market site map for acquiring raising control information.

A market site 555 is accessible by a user by the portable communication terminal 200 in the cultivation system 100. By the user following desired items, the user can select desired raising control information from multiple pieces of raising control information accumulated in the recording apparatus 400.

The market site 555 may be a site of the owner of the cultivation system 100, may be a site of a seed and seedling seller or an agricultural cooperative, or may be a site of a social network.

For example, as shown in FIG. 20, as a plant species, “vegetables”, “flowers”, “grasses and trees”, or “fruits” can be selected. For example, when the “vegetables” is selected, a vegetable species such as “lettuces” or “small tomatoes” can be selected. For example, when the “lettuces” is selected, a taste such as “sweet” or “bitter” and a size such as “large” or “small” can be selected. For example, when the “sweet” is selected, a plurality of pieces of raising control information for raising a lettuce that features sweetness can be selected. For the raising control information, free information A, 50-yen information B, 10,000-yen information C, and the like are presented. User evaluation may be displayed in icon format in conjunction with the raising control information.

The user can select one of the plurality of pieces of raising control information and download the raising control information to the portable communication terminal 200. The downloaded information can be used as raising control information to be transmitted to the cultivation apparatus 300.

As described above, in the cultivation system 100 of the present invention, growth information transmitted from a cultivation apparatus 300 which is controlled by a user and raising control information transmitted to the cultivation apparatus are analyzed by the cloud 500, and results of the analysis of the growth information and the raising control information are given back in a mode where the user him/herself can use the results of the analysis, to control the cultivation apparatus 300 in the cultivation system 100. By this, use of the cultivation system 100 by the user is promoted, creating a virtuous cycle of creation of more useful plants.

In the cultivation system 100 of the present invention, since a raising control plan is proposed by automatic feedback performed by the cloud 500, the user can leave at least one of all or some of the steps in a raising step and all or some of a plurality of raising conditions to be provided simultaneously, to a cloud's judgment.

In the cultivation system 100 of the present invention, the results of analysis performed by the cloud 500 on growth information can be displayed on the display screen 210 of the user's portable communication terminal 200, converted into a simple display format. Thus, general users with no expert knowledge can easily handle, for example, useful information about a growth state which is handled by experts such as researchers and producers (as expert information or as intuition), and thus can set raising control conditions on their own.

In the cultivation system 100 of the present invention, a part of the raising control information transmitted to the cultivation apparatus 300 from the communication terminal 200 can be based on a raising control information plan proposed by automatic feedback by the cloud 500. In addition, the user can use raising control information acquired from another user, for at least one of only some of the steps in a raising step and some of a plurality of raising conditions to be provided simultaneously. Hence, user's original raising control information can be easily constructed.

In the cultivation system 100 of the present invention, different prices are set for purchased raising control information, in accordance with at least one of the taste, nutrients, outer appearance, size, shape, number of purchases, repurchase rate, and purchasing group of a harvest resulting from the growth of a plant, and the number of purchases and purchasing group of the raising control information. Thus, the price based on the evaluation of a harvest can be set.

In the cultivation system 100 of the present invention, pieces of growth information transmitted from other users' cultivation apparatuses 300 are displayed on the display screen 210 of the portable communication terminal 200, as animation objects 241A to 241D which are created by the cloud 500. Thus, the user can check the current states of growth controlled by other users, in a high reliability state and in a very short period of time. Furthermore, when the user wants to purchase other users' raising control information, the user can efficiently access raising control information for obtaining excellent growth results.

In the cultivation system 100 of the present invention, the lighting apparatuses 310, 310c, 310d, 310e, and 310f in the cultivation apparatus 300 are formed of the lighting units 3100, 3100a, 3100b, 3100c, and 3100e that include light sources and the boards 3110, 3110a, 3110b, 3110c, and 3110e to which the light sources are fixed. The boards 3110, 3110a, 3110b, 3110c, and 3110e have a shape that allows extension by coupling to other boards. Thus, by coupling a plurality of lighting units 3100, 3100a, 3100b, 3100c, and 3100e together, a lighting apparatus can be formed that has a desired size and shape, in accordance with a plant and/or various circumstances such as a plant growth location. Therefore, for example, excellent irradiation efficiency can be ensured and non-uniform irradiation can be prevented.

In the cultivation system 100 of the present invention, the communication terminal 200 receives raising control information from a near field communication apparatus, and transmits the received raising control information to the cultivation apparatus 300 via the cloud 500, by which raising control information that is not present in the cloud can also be obtained.

In the present invention, the cultivation system 100 corresponds to a “cultivation system”, the cultivation apparatus 300 corresponds to a “cultivation apparatus”, the portable communication terminal 200 corresponds to a “communication terminal”, the recording apparatus 400 corresponds to a “recording apparatus”, the cloud 500 corresponds to a “cloud”, the lighting apparatuses 310, 310c, 310d, 310e, and 310f correspond to “lighting apparatuses”, the images 241A to 241D correspond to “animation objects”, and FIGS. 13, 17, and 18 correspond to a cultivation program and a cultivation method.

A preferred embodiment of the present invention is as described above, but the present invention is not limited thereto. It is to be understood that various other embodiments may be performed without departing from the spirit and scope of the present invention. Furthermore, although in the embodiment the functions and effects brought about by the configuration of the present invention are described, the functions and effects are an example and thus do not limit the present invention.

1. A cultivation system comprising:
a cultivation apparatus that grows a plant, transmits growth information to a cloud, and receives raising control information from the cloud; and
a communication terminal that receives a result of analysis performed by the cloud on at least one of the growth information and the raising control information, and transmits raising control information generated based on the result of analysis to the cultivation apparatus through the cloud.

2. The cultivation system according to claim 1, wherein the result of analysis performed by the cloud is a raising control plan proposed by automatic feedback performed by the cloud.

3. The cultivation system according to claim 1, wherein the result of analysis performed by the cloud is information obtained by converting the result of analysis of the growth information into a simple display format.

4. The cultivation system according to claim 2, wherein a part of the raising control information transmitted to the cultivation apparatus from the communication terminal is based on the raising control information plan proposed by automatic feedback performed by the cloud.

5. The cultivation system according to claim 1, wherein
one communication terminal that controls one cultivation apparatus through the cloud can acquire raising control information for another cultivation apparatus controlled by another communication terminal through the cloud, and
a part of raising control information transmitted to the one cultivation apparatus from the one communication terminal is acquired raising control information.

6. The cultivation system according to claim 1, wherein
one communication terminal that controls one cultivation apparatus through the cloud can purchase raising control information for another cultivation apparatus controlled by another communication terminal through the cloud, and
different prices are set for the purchased raising control information, in accordance with at least one of a taste, a nutrient, an outer appearance, a size, a shape, a number of purchases, a repurchase rate, and a purchasing group of a harvest resulting from growth of the plant, as well as a number of purchases and a purchasing group of the raising control information.

7. The cultivation system according to claim 1, wherein
the growth information includes a plurality of images of the plant controlled by one communication terminal, the images being obtained at different times in one growth process, and
an animation object formed of the plurality of images and created by the cloud is displayed on another communication terminal.

8. The cultivation system according to claim 7, wherein the other communication terminal displays animation objects of plants controlled by a plurality of communication terminals including the one communication terminal, such that the animation objects can be compared with each other.

9. The cultivation system according to claim 1, wherein
the cultivation apparatus includes a lighting apparatus that irradiates the plant with a light and that is formed of lighting units, each including a light source and a board to which the light source is fixed, the board having a shape that allows extension by coupling to another board, and
the raising control information includes light irradiation control information of the lighting apparatus.

10. The cultivation system according to claim 1, further comprising a near field communication apparatus having raising control information of the plant, wherein
the communication terminal receives the raising control information from the near field communication apparatus, and controls the cultivation apparatus through the cloud based on the received control information.

11. A program for a cultivation apparatus, the program comprising:
a process by a cultivation apparatus of transmitting growth information to a cloud and receiving raising control information from the cloud, the cultivation apparatus growing a plant;
a process by the cloud of analyzing at least one of the growth information and the raising control information; and
a process by a communication terminal of receiving a result of the analysis performed by the cloud and transmitting raising control information generated based on the result of the analysis to the cultivation apparatus through the cloud.

12. A method for a cultivation apparatus, the method comprising:
a step by a cultivation apparatus of transmitting growth information to a cloud and receiving raising control information from the cloud, the cultivation apparatus growing a plant;
a step by the cloud of analyzing at least one of the growth information and the raising control information; and
a step by a communication terminal of receiving a result of the analysis performed by the cloud and transmitting raising control information generated based on the result of the analysis to the cultivation apparatus through the cloud.
